(19) United States
(12) Patent Application Publication
(10) Pub. No.: US 2026/0280934 A1
(43) Pub. Date: Sep. 17, 2026

(54) ZTNA-Enabled VPN Solution

(71) Applicant: Zscaler, Inc., San Jose, CA (US)

(72) Inventors: Rupesh Kumar, Milpitas, CA (US); Deepak Mohanty, Santa Clara, CA (US); Naga Sunil Tripirineni, San Jose, CA (US); Nikolaos Triantafillis, San Jose, CA (US); Joby Menon, Cupertino, CA (US); Shiva Krishnamurthy, San Jose, CA (US); Omar Jaber, Bellevue, WA (US); John A. Chanak, Saratoga, CA (US)

(73) Assignee: Zscaler, Inc., San Jose, CA (US)

(21) Appl. No.: 19/078,532

(22) Filed: Mar. 13, 2025

(51) Int. Cl. H04L 12/46; G06F 21/44; H04L 9/08

(52) U.S. Cl. CPC H04L 12/4641; G06F 21/44; H04L 9/08

(57) ABSTRACT

A Zero-Trust Network Access (ZTNA)-enabled Virtual Private Network (VPN) solution combines traditional VPN tunnels with ZTNA’s application-centric controls. Rather than granting broad network access, the system enforces fine-grained policies based on identity, device posture, and contextual factors. By positioning a cloud-based overlay between end users and private applications or LAN segments, it enables continuous verification and least-privileged access for both legacy and modern workloads. Key components—such as NP gateways, NP connectors, and application connectors—create outbound-only tunnels, eliminating the need for open inbound ports. Leveraging protocol-agnostic or WireGuard-based encryption, these tunnels transport traffic securely while preventing unauthorized visibility or lateral movement. Users benefit from robust, real-time security checks, application-specific routes, and seamless scalability. This hybrid approach delivers both network-level connectivity for VoIP or server-initiated flows and granular ZTNA for application access, minimizing attack surfaces and reducing operational complexity in modern, distributed environments.

### FIELD OF THE DISCLOSURE

The present disclosure relates generally to networking and computing. More particularly, the present disclosure relates to systems and methods for a zero-trust network access (ZTNA)-enabled virtual private network (VPN) solution.

### BACKGROUND OF THE DISCLOSURE

ZTNA and VPNs both enable remote access, but they differ fundamentally in their underlying security approaches. VPNs, rooted in a traditional “castle-and-moat” model, grant users broad, network-level access once connected, which can expose more resources than necessary. In contrast, ZTNA applies a “never trust, always verify” philosophy, providing only application-specific, least-privileged access. This approach reduces an organization’s attack surface, limits lateral movement, and offers granular, context-based controls. In modern hybrid and cloud environments, ZTNA’s application-centric approach often delivers stronger security, better performance, and simpler scalability compared to conventional VPNs. Instead of extending the entire corporate network to remote users, cloud-based ZTNA solutions authenticate and authorize each connection at the application level, eliminating the need for on-premises hardware and avoiding inbound port exposure. As a result, they provide a more seamless and secure user experience overall.

A traditional VPN typically operates at lower layers of the OSI model (Layer 2 or Layer 3). When a user connects to a VPN, they are effectively placed inside the corporate network at the IP or Ethernet level and assigned an internal IP address. From the network’s perspective, this user appears “inside” the organization, with broad visibility into network segments. By contrast, ZTNA focuses on higher-layer (often Layer 7) connections. Instead of granting full network access, it brokers user requests to specific applications. This means users cannot explore or discover IP addresses or services beyond what they are explicitly authorized to access, significantly reducing the risk of lateral movement.

While ZTNA provides clear operational and security benefits, there are some scenarios where it may not be the optimal choice. Certain applications, such as Voice over IP (VoIP) or those relying on server-initiated connections, require continuous, end-to-end network connectivity. For example, VoIP often involves real-time transmission over multiple dynamic ports and demands low latency—requirements that can be difficult to satisfy within ZTNA’s more controlled, application-layer model. Likewise, in server-to-client communications, the server initiates the connection rather than simply receiving requests, which does not align well with ZTNA’s user-initiated, application-specific approach.

### BRIEF SUMMARY OF THE DISCLOSURE

The present disclosure introduces a Zero-Trust Network Access (ZTNA)-enabled Virtual Private Network (VPN) solution that merges the granular, application-centric security of ZTNA with the continuous, network-layer connectivity of traditional VPNs. By embracing least-privileged access, the solution mitigates the risk of lateral movement and reduces attack surfaces. Unlike legacy VPNs that grant unfettered access at the IP or Ethernet layer, the disclosed approach leverages network presence (NP) to provide user devices with secure tunnels into a cloud-based system, enforcing zero-trust policies throughout. This design supports bidirectional or real-time workloads—such as VoIP or server-initiated connections—yet retains application-specific controls for private resources. The cloud-based system uses NP gateways and NP connectors to create outbound-only tunnels, removing the need for open inbound ports. Further, it integrates seamlessly with existing identity providers and posture checks, allowing dynamic, context-aware validation of devices and users. Overall, this hybrid ZTNA-enabled VPN architecture delivers scalability, improved user experience, and robust security that addresses the shortcomings of both standalone VPN and ZTNA solutions.

### BRIEF DESCRIPTION OF THE DRAWINGS

The present disclosure is illustrated and described with reference to the various drawings. Like reference numbers are used to denote like components/steps, as appropriate. Unless otherwise noted, components depicted in the drawings are not necessarily drawn to scale.

FIG. 1 illustrates a network diagram of a cloud-based system that provides various services, including ZTNA access to applications.

FIG. 2 illustrates a block diagram of a computing system that may be used to implement various components described in this disclosure.

FIG. 3 illustrates a network that includes components within the cloud-based system for delivering ZTNA-enabled VPN access to two example client endpoint devices.

FIG. 4 illustrates a flowchart of a process for enabling zero-trust network access (ZTNA)-enabled virtual private network (VPN) connectivity in a cloud-based system that includes a network presence (NP) gateway.

FIG. 5 illustrates a flowchart of a process for providing zero-trust network access (ZTNA) private application connectivity and ZTNA-enabled virtual private network (VPN) connectivity.

### DETAILED DESCRIPTION OF THE DISCLOSURE

Again, a VPN solution allows remote users to securely access an organization’s internal network as if they were physically present onsite. By creating a tunnel at the Internet Protocol (IP) or Ethernet level (Layer 2 or Layer 3 of the OSI model), VPNs assign a remote device an internal IP address and route all user traffic through a VPN concentrator. This effectively extends the corporate network to the user’s location, making it straightforward to access resources such as file servers, intranet sites, or enterprise apps. VPNs also support applications that require continuous, end-to-end connectivity—like Voice over IP (VoIP)—because they provide the equivalent of a local network connection, maintaining persistent sessions and real-time data transfer. Additionally, organizations can choose from a variety of well-established VPN protocols (e.g., IP Security (IPSec), secure sockets layer (SSL)/transport layer security (TLS)) to encrypt traffic, ensuring data privacy over untrusted networks like the public internet.

However, this broad network-level access also presents security challenges. Once connected, a remote device is effectively “inside” the corporate firewall, creating a larger attack surface. If a malicious actor compromises a remote user’s device, they can exploit the VPN tunnel to move laterally across the internal network, probing and potentially accessing systems that were never intended to be exposed. Even if firewalls or access control lists partially restrict certain network segments, attackers can still gain valuable insight into network topology and services running on the internal infrastructure. Moreover, managing and segmenting access for every VPN user can become complex, especially in larger environments. These factors make VPNs a double-edged sword: indispensable for certain scenarios requiring full network connectivity, yet prone to increasing the organization’s overall risk posture if not carefully implemented and maintained.

### Cloud-based system

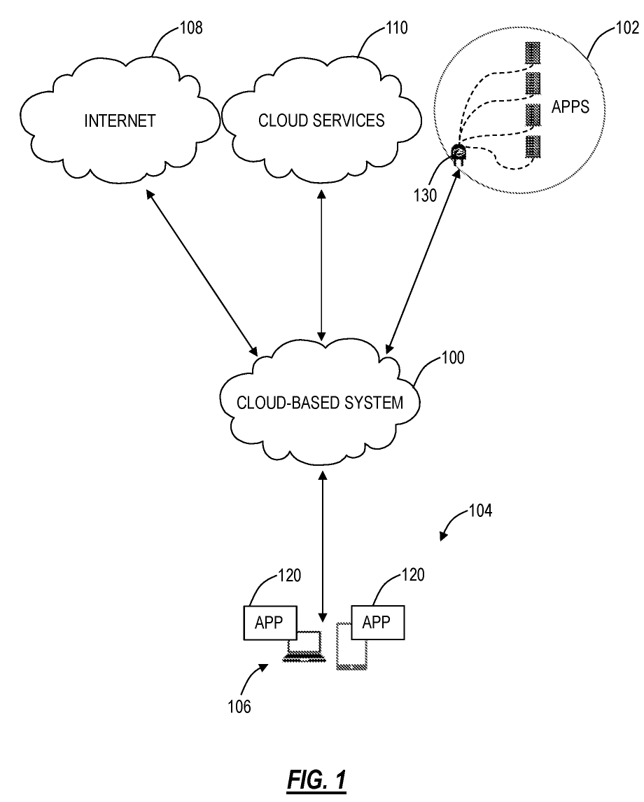

To address the limitations of traditional VPN solutions, organizations have adopted Zero Trust Network Access (ZTNA) as part of a cloud-based security model. FIG. 1 illustrates a network diagram of a cloud-based system 100 that provides various services, including ZTNA access to applications 102. In this architecture, the cloud-based system 100 serves as a secure intermediary between users 104 (and their endpoint devices 106), the Internet 108, cloud services 110, and private applications 102. In addition to ZTNA, the cloud-based system 100 can implement services like a secure web gateway (SWG), secure service edge (SSE), and secure access service edge (SASE). A tenant—such as an enterprise or other organization—manages users 104, who access these cloud services via corresponding endpoint devices 106. While the term “user” 104 is used throughout, it implies use of an associated endpoint device 106 for interacting with the cloud-based system 100. Also, the cloud-based system 100 support multi-tenancy, namely users 104 from different tenants, with granular policies, reporting, etc.

Logically, the cloud-based system 100 functions as an overlay network that provides security and connectivity services independently of physical geography, local platform constraints, or network providers. In traditional IT deployments, enterprise resources and applications were hosted in a corporate data center behind a firewall, with remote users accessing them via VPN tunnels that often granted broad network-level access. By contrast, the cloud-based system 100 replaces this perimeter-focused model with a cloud-delivered approach. Instead of installing and managing numerous physical devices and appliances, enterprise IT administrators rely on the cloud-based system 100 to perform the same functions—securely brokering traffic and providing zero-trust controls—wherever users 104 are located. This design not only relieves organizations of managing hardware appliances but also reduces the attack surface by minimizing the need for inbound open ports and traditional VPN concentrators.

A key advantage of the cloud-based system 100 is that it intercepts and inspects all user traffic, enabling powerful security features such as zero-trust enforcement. Different techniques can be used to direct traffic through the cloud-based system 100. In some deployments, specific sites establish tunnels (e.g., GRE, L2TP, IPsec) that forward all traffic to the cloud-based system 100, while in others, endpoint devices 106 run a client connector 120 that intelligently routes traffic. Regardless of the method, the result is that all data flowing between users 104 and the Internet 108, cloud services 110, or applications 102 passes through the cloud-based system 100. By operating as an always-on overlay network, the cloud-based system 100 applies zero-trust principles—verifying user identity, device posture, and application context—without relying on a broad, network-layer tunnel. In doing so, it addresses the key challenges of legacy VPN solutions: reducing the attack surface, preventing lateral movement, and eliminating the need for users to join the corporate network at a lower OSI layer.

### Client Connector

The client connector 120 is a lightweight software agent installed on endpoint devices 106—such as laptops, desktops, or mobile devices—that securely routes user traffic to the cloud-based system 100. Once installed, it inspects system attributes (e.g., OS version, security posture) and applies policy-based controls to determine whether traffic should be forwarded for further inspection or enforcement. Operating at the network and application layers, the client connector 120 leverages domain name system (DNS) interception or tunneling technologies to capture both web and non-web traffic. It then directs these data flows to the cloud-based system 100, where a suite of security services—such as SWG, cloud firewall, cloud sandbox, data loss prevention (DLP), ZTNA, and the like—are applied based on granular, context-aware policies. By dynamically evaluating user identity, device health, and application context, the client connector 120 facilitates a zero-trust model for secure connectivity, helping organizations extend consistent security controls to remote or mobile users without forcing all traffic back through on-premises gateways.

### ZTNA

By contrast to VPNs, a ZTNA private application access solution operates at higher layers of the OSI model (often Layer 7), providing granular, application-level security rather than granting broad network access. In the architecture shown in FIG. 1, the cloud-based system 100 authenticates and authorizes each connection request at the application layer, ensuring the user 104 only sees and accesses the specific resources they are permitted to reach. To facilitate this, the user 104 connects to the applications 102—which may reside in an enterprise network, a data center, or a public or private cloud—through an application connector 130. This connector 130 sits between the endpoint device 106 and the applications 102, validating user identity, device posture, and contextual factors (e.g., location or time of day) before granting a tailored, least-privileged session. Traffic then flows through secure tunnels that are created on demand via the cloud-based system 100, but crucially, these tunnels do not expose the underlying network topology. Instead, the applications 102 remain “dark” to the outside world, which drastically reduces the corporate attack surface and prevents lateral movement. This design aligns well with modern, cloud-heavy deployments by offering simpler scalability, granular security policies, and more robust controls than traditional VPNs that operate at lower network layers.

ZTNA’s focus on application-level connections can pose challenges for certain workloads that require continuous, bidirectional, or real-time communication at the network layer. For example, Voice over IP (VoIP) often relies on dynamic port assignments, real-time audio/video streams, and consistent end-to-end connectivity—attributes that are difficult to accommodate when access is brokered at the application layer without direct network visibility. Likewise, server-initiated communications (e.g., remote management tools or specific legacy protocols) depend on the ability to reach client devices on-demand, which ZTNA’s “outbound-only” or “user-initiated” tunnel model does not readily support. Because ZTNA does not assign remote endpoints a network address inside the corporate environment, it cannot easily route inbound traffic from servers to clients, nor can it handle protocols expecting unfettered LAN-like access. Consequently, while ZTNA excels at securing user-to-application interactions, traditional VPNs may still be necessary for use cases involving continuous or server-led network traffic that ZTNA’s strictly controlled, application-specific approach struggles to handle.

### Application Connector

The application connector 130, also referred to as an app connector, is a lightweight software component deployed at the application 102, which can be in an organization’s network, a data center, etc.—typically in the same subnet or environment where the private application 102 resides. The application connector 130 provides secure, outbound-only connectivity between the application 102 and authorized remote users 104. Unlike traditional VPN concentrators that require inbound ports and network-layer tunnels, the application connector 130 builds a secure, outbound connection or tunnel (e.g., TLS) to the cloud-based system 100.

Deployment Location & Network Topology--The application connector 130 can be installed on a virtual machine (or sometimes a physical server) within the organization’s own environment (data center, private cloud, public cloud, etc.). The application connector 130 can sit behind a corporate firewall but does not require any inbound ports to be opened. Instead, the connector 130 initiates an outbound 443/TLS connection to the cloud-based system 100, ensuring that no listening services are exposed on the public internet.

Outbound-Only Connectivity—All communication between the connector 130 and the cloud-based system 100 is initiated from inside the network. This outbound-only model eliminates the need for public IPs or inbound network address translation (NAT) rules. The connector 130 maintains a persistent secure tunnel to the cloud-based system 100, which serves as the rendezvous point for remote-user sessions.

Application Discovery & Mapping—Administrators define “application segments” within tan admin console, associated with the cloud-based system 100, specifying fully qualified domain names (FQDNs), IP ranges, and TCP/UDP ports that represent the internal services to be published. The connector 130 is associated with these application segments, so it “knows” which private applications it can broker access to. This ensures that only explicitly configured resources are accessible; anything else remains invisible (“dark”) to external users 104.

Dynamic Session Brokering—When a remote user 104 requests access to a private application 102, the cloud-based system 100 verifies the user’s identity, device posture, and contextual policy checks (e.g., time of day, geolocation, etc.). If authorized, the cloud-based system 100 instructs the connector 130 to accept the user session. Traffic from the user 104 flows through a separate secure tunnel from the user’s device to cloud-based system 100, which then stitches it together with the connector’s 130 outbound tunnel from the application 192—without ever exposing the internal network or assigning the user 104 a local IP address.

Context-Aware Security Enforcement—The connector 130 does not simply “port forward” or provide network-layer bridging. Instead, it enforces a Zero Trust model at the application layer, allowing access only to the FQDNs/ports specified by policy. This granular, application-level control prevents lateral movement. Even if an attacker compromised a user’s endpoint device 106, they would only be able to reach the specifically authorized application instances.

Scalability & High Availability—Multiple application connectors 130 can be deployed across different environments or geographic locations to scale capacity or provide redundancy. Each connector 130 is managed centrally from the admin console. Because each connector 130 creates an outbound link to the same cloud-based system 100, organizations can expand or contract deployments without rearchitecting networks or provisioning new public IP addresses.

Reduced Attack Surface—By eliminating inbound connections and relying on user- and application-level policies, the application connector 130 significantly reduces an organization’s external attack surface. The private applications 102 remain “dark”—unexposed to port scans or direct internet probing—since the only incoming path is via the cloud-based system’s 100 authenticated and authorized sessions.

Integration with Existing Infrastructure—The application connector 130 can coexist with existing firewall, proxy, or network equipment. It usually only needs outbound access on port 443. It also integrates with identity providers and endpoint posture checks to enforce consistent policies for both internal and remote users.

In essence, the application connector 130 acts as a “reverse connector” that projects private applications 102 into the cloud-based system 100, where zero-trust policies can be enforced for remote users. Because it operates at higher layers of the OSI model and never grants broad network access, it embodies the core Zero Trust principle of “least-privileged access,” thereby minimizing lateral movement risks and overall exposure.

### Computing System

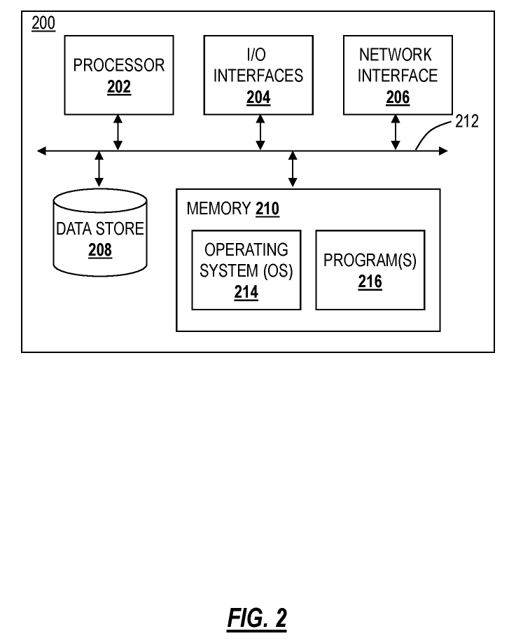

FIG. 2 illustrates a block diagram of a computing system 200 that may be used to implement various components described in this disclosure. The computing system 200 can take multiple forms, including but not limited to laptops, desktops, smartphones, tablets, physical servers, clusters of machines, virtual machines (VMs) running on hypervisors, or serverless computing frameworks. Despite differing hardware implementations, the computing system 200 generally comprises one or more processors 202, input/output (I/O) interfaces 204, a network interface 206, a data store 208, and memory 210. While FIG. 2 provides a simplified representation, real-world deployments can include additional hardware and software elements. These components 202, 204, 206, 208, 210 connect via a local interface 212, which may include wired or wireless buses, high-speed interconnects, or other switching fabrics.

Each processor 202 is a hardware element—such as a central processing unit (CPU), multicore processor, system-on-chip (SoC), graphics processing unit (GPU), or a processing element within a larger compute cluster—designed to execute software instructions. These processors can be general-purpose or specialized, depending on performance, power efficiency, or workload requirements. During operation, each processor 202 retrieves instructions from memory 210, manages data within the data store 208, and orchestrates the overall functioning of the computing system 200. In larger-scale environments, multiple processors 202 may run in parallel to handle higher volumes of network traffic or complex workloads.

The I/O interfaces 204 allow the computing system 200 to interact with external peripherals for user input (e.g., keyboards, touchscreens, sensors) and system output (e.g., displays or printers). Depending on the application, these I/O interfaces 204 can also connect to specialized devices for maintenance, debugging, or administrative tasks. Meanwhile, the network interface 206 manages connectivity to external networks—whether the Internet, private intranets, or cloud-based environments. This interface can utilize Ethernet, wireless LANs, cellular connections, or virtual cloud endpoints. By employing secure transport protocols (e.g., TLS/SSL, IPsec), the network interface 206 ensures that data exchange with remote entities remains protected, allowing the computing system 200 to operate safely in distributed or cloud-focused deployments.

The data store 208 provides both persistent and temporary storage. It can encompass volatile memory (e.g., random access memory (RAM)) for high-speed operations and nonvolatile media (e.g., solid-state drives, hard disk drives, optical discs) for long-term data retention. In some configurations, the data store 208 may integrate with network-attached storage (NAS), storage area networks (SAN), or cloud-based storage solutions. These setups can range from small on-premises installations to large, geographically distributed systems offering deduplication, compression, encryption at rest, and multi-site replication. The data store 208 may hold operational logs, system configurations, policy rules, software binaries, or cached computation results.

The memory 210 typically functions as the primary working memory for the processors 202. It can include volatile elements (e.g., dynamic RAM (DRAM), double data rate (DDR), synchronous DRAM (SDRAM)) for faster access, as well as nonvolatile components like flash memory or non-volatile RAM (NVRAM). In large-scale cloud environments, memory 210 may be distributed across multiple nodes or servers to support in-memory processing for high-throughput workloads. Typically, the memory 210 stores the operating system (O/S) 214 and one or more programs 216. The O/S 214 manages core system functions such as process scheduling, memory allocation, file handling, and network communication.

For Software-as-a-Service (SaaS) or similar cloud-hosted components—such as those in the cloud-based system 100—the computing system 200 can be deployed in diverse ways: within a private cloud in a single organization’s data center, through a public cloud provider, or as part of a hybrid cloud model combining both. Cloud computing decouples the physical layer of servers, storage, and networks into virtualized, on-demand resources. Organizations can thus scale compute capacity, storage, and network bandwidth rapidly and cost-effectively, aligning with fluctuating workloads. As defined by the U.S. National Institute of Standards and Technology (NIST), cloud computing is “a model for enabling convenient, on-demand network access to a shared pool of configurable computing resources (e.g., networks, servers, storage, applications, and services) that can be rapidly provisioned and released with minimal management effort or service provider interaction.” By delivering applications via web interfaces or lightweight clients, cloud providers can consistently push updates, deploy new features, and enforce security patches, minimizing the overhead typically associated with local installations and version management.

Different embodiments of the computing system 200 may employ various forms of processing hardware, including general-purpose microprocessors, digital signal processors (DSPs), network processors, graphics processors (GPUs), field-programmable gate arrays (FPGAs), or programmable logic devices (PLDs). Such hardware can be managed by software, firmware, or both, and may work in tandem with dedicated circuitry to accomplish specific tasks. Certain operations can be implemented via state machines or in application-specific integrated circuits (ASICs) to optimize performance and power efficiency. Additionally, implementations can leverage a non-transitory, computer-readable storage medium containing instructions that, when executed by the computing system 200, cause it to perform the methods or algorithms described herein. Common examples of such storage media include hard disks, optical discs, magnetic storage, read-only memory (ROM), flash memory, and other types of persistent or semi-persistent storage. Once stored and executed, these instructions enable the system to implement the disclosed functionality.

### ZTNA-Enabled VPN Solution

A ZTNA-enabled VPN solution combines the strengths of both VPN and ZTNA models to address the limitations of traditional VPNs while improving overall security, scalability, and user experience. In this hybrid architecture, the familiar VPN framework is enhanced by zero-trust principles, ensuring continuous verification of user identity, device posture, and application context. More specifically, the ZTNA-enabled VPN solution provides network presence (NP) for a user 104 through the cloud-based system 100—for instance, via a WireGuard-based tunnel—allowing endpoint devices 106 to operate at the network layer for use cases such as VoIP, server-initiated connections, and other real-time or bidirectional applications. Crucially, ZTNA enforcement is applied within this VPN tunnel, preventing unrestricted lateral movement and limiting access to only the resources that are explicitly authorized.

Network Presence (NP) was introduced to fulfill two example requirements: extending ZTNA to support VoIP traffic and providing a more traditional, full-tunnel VPN solution. For VoIP scenarios, NP incorporates a pseudo-STUN component that handles real-time communication; in practice, this also accommodates protocols like H.323, which do not rely on SIP or STUN. Concurrently, some customers requested an “old-school” VPN approach to ensure continuous network connectivity—an approach that likewise supports VoIP. NP modernizes this legacy VPN model by implementing per-destination controls instead of granting blanket network access. Moreover, unlike older VPN gateways that reside in a local area network (LAN) or demilitarized zone (DMZ) and require inbound firewall ports to be opened, NP initiates tunnel connections from inside the LAN, removing the need for any externally exposed ports. This design upholds a zero-trust posture, reduces the attack surface, and offers the network-layer visibility essential for VoIP and server-to-client communications.

Meanwhile, the solution preserves traditional ZTNA application access via the application connector 130, delivering granular, application-specific connectivity without exposing the entire network. This ensures that users 104 benefit from both a network presence (when lower-layer protocols are necessary) and the robust, per-application security of ZTNA. Additionally, the ZTNA-enabled VPN solution can integrate with existing identity providers and device posture checks, supporting conditional policies such as time-of-day restrictions, geolocation filtering, and multifactor authentication. Altogether, this approach grants enterprises the flexibility to accommodate a wide range of application types—including those requiring full network connectivity—while adhering to zero-trust best practices to minimize attack surfaces and mitigate the risk of lateral movement.

Benefits of this hybrid approach include:

Enhanced Security—Granular Access Control: ZTNA ensures that users are granted access only to specific applications and resources based on identity, device health, location, and context. This limits unauthorized access and reduces the risk of lateral movement within the network. Continuous Verification: Unlike VPNs that authenticate users only at the point of entry, ZTNA continuously verifies user and device trust throughout the session, minimizing the risk of compromised sessions. Minimized Attack Surface: With ZTNA, applications remain hidden from the public internet, reducing exposure to external threats such as DDoS attacks, malware, and unauthorized access.Micro-Segmentation: ZTNA enforces strict segmentation, ensuring that even if one part of the network is compromised, other segments remain secure.

Improved Scalability and Flexibility—Cloud-Native Architecture: ZTNA solutions often leverage cloud infrastructure, making it easier to scale as organizational needs grow without the limitations of traditional VPN hardware. Device Agnosticism: Supports secure access from a variety of devices, including BYOD, mobile, and desktops, without compromising security.

Seamless User Experience—Optimized Performance: ZTNA directs traffic through the nearest points of presence, reducing latency compared to routing all traffic through a central VPN gateway. Simplified Access Management: Users gain secure access to necessary applications without complex VPN configurations.

Reduced Operational Overhead—Centralized Policy Management: Administrators can define and enforce access policies centrally, ensuring consistency.

Addressing VPN Limitations—Eliminates Overly Broad Access: ZTNA limits access to only necessary resources, reducing potential damage from compromised accounts. Mitigates VPN Performance Bottlenecks: ZTNA’s distributed architecture reduces strain on VPN servers.

Addressing ZTNA Shortcomings with VPN Integration—Support for Legacy Systems: Pure ZTNA solutions may not support legacy applications reliant on traditional network access; a ZTNA-enabled VPN can bridge this gap. Comprehensive Connectivity: ZTNA alone may face challenges in providing full network connectivity required by some enterprise applications; integrating VPN ensures seamless access. Reduced Implementation Complexity: Deploying ZTNA from scratch can be complex; integrating it with an existing VPN infrastructure allows a smoother transition. Fallback Mechanism: In scenarios where ZTNA policies face misconfigurations or failures, the VPN component can serve as a fallback to ensure uninterrupted access.

A ZTNA-enabled VPN solution provides a robust, secure, and scalable framework for modern organizations, combining the trusted remote access of VPNs with the dynamic, context-aware controls of ZTNA. This hybrid approach not only enhances security and performance but also addresses the limitations of both VPN and ZTNA, offering the best of both worlds in network security and access management.

### ZTNA-enabled VPN Architecture

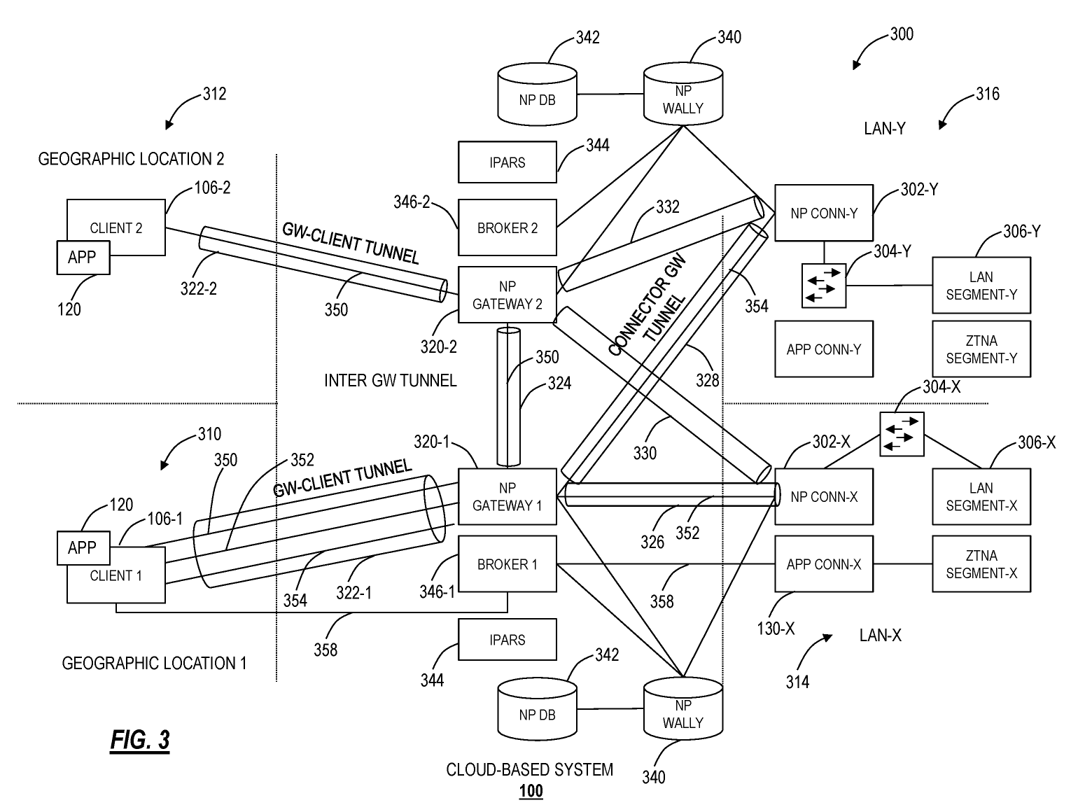

FIG. 3 illustrates a network 300 that includes components within the cloud-based system 100 for delivering ZTNA-enabled VPN access to two example client endpoint devices 106-1, 106-2. Of note, the example network 300 is simplified for illustrative purposes, and actual deployments will include additional components. In this architecture, network presence (NP) connectors 302-X, 302-Y function similarly to the application connectors 130, but reside in front of gateways (GW) 304-X, 304-Y that serve LAN segments 306-X, 306-Y rather than private applications 102. The NP connectors establish secure tunnels (e.g., WireGuard-based) with the cloud-based system 100, providing ZTNA-like controls for network-level access—particularly useful for VoIP, server-to-client connections, and other workloads requiring bidirectional or real-time communication.

Critically, the NP connectors 302-X, 302-Y enforce zero-trust policies for LAN resources in the same way application connectors 130 do for individual applications 102, yet focus on granting LAN access instead of per-application access. This approach enables users 104 to reach lower-layer network services without exposing the entire LAN or requiring inbound firewall ports. At the same time, the application connector 130 remains available to deliver granular, application-level security for private applications 102. In practice, both connectors work in tandem through a single client connector 120 on each endpoint device 106, enabling seamless user access to LAN-based resources via NP connectors 302-X, 302-Y while also providing traditional, application-specific ZTNA through the application connector 130. This unified design preserves zero-trust enforcement across all connectivity scenarios, minimizes the attack surface, and offers the flexibility needed to support a wide variety of application requirements.

FIG. 3 depicts a simplified example of a network 300 with two geographic locations 310 and 312, each hosting a respective client endpoint device (106-1, 106-2) equipped with a client connector 120. These locations can be remote offices, user homes, hotels, or public Wi-Fi hotspots. The network 300 also includes two local area network (LAN) segments, 314 (labeled LAN-X) and 316 (labeled LAN-Y). Positioned as an overlay between the geographic locations 310, 312 and the LAN segments 314, 316 is the cloud-based system 100, which orchestrates ZTNA-enabled VPN connectivity and enforces zero-trust policies.

Within this setup, the client endpoint devices 106-1 and 106-2 establish secure connections—referred to as GW-client tunnels 322-1, 322-2—to NP gateways 320-1, 320-2 in the cloud-based system 100. These tunnels are commonly implemented via WireGuard or similar protocols, with the client connector 120 configured as an NP client to support such connectivity. The NP gateways 320-1, 320-2 are themselves linked by an inter-GW tunnel 324, enabling seamless traffic flow within the cloud-based system 100. From each NP gateway 320-1, 3202, additional connector GW tunnels 326, 328, 330, 332 extend to the LAN segments 314, 316, terminating at the NP connectors 302-X, 302-Y. These NP connectors 302-X, 302-Y provide zero-trust network access to LAN resources—such as VoIP systems or server-to-client applications—while ensuring no inbound firewall ports need to be opened. The cloud-based system 100 also includes an NP Wally module 340, an NP database (DB) 342, an IP management system (IPARS) 344, and multiple application brokers 346-1, 346-2, which handle aspects like policy enforcement, IP address allocation, and application-level routing.

For illustrative connectivity scenarios, the endpoint device 106-1 can communicate with endpoint device 106-2 via a connection 350 that traverses GW-client tunnel 322-1, NP gateway 320-1, the inter-GW tunnel 324, the NP gateway 320-2, and the GW-client tunnel 322-2. This allows for ZTNA-enforced client-to-client connectivity without exposing sensitive infrastructure. Similarly, the endpoint device 106-1 can access LAN segment 314 over a connection 352 that flows through the GW-client tunnel 322-1, the NP gateway 320-1, the connector GW tunnel 326, and finally reaches the NP connector 302-X. A comparable connection 354 lets the endpoint device 106-1 reach the LAN segment 316 via the connector GW tunnel 328 and the NP connector 302-Y. Meanwhile, the endpoint device 106-1 can separately leverage application brokers 346-1, 346-2 for private application access via ZTNA. For example, a connection 358 may involve distinct secure tunnels from the endpoint device 106-1 to the application broker 346-1 and from there to an application connector 130-X, ultimately providing per-application security. In this manner, a single endpoint device 106-1 can seamlessly utilize both ZTNA-enabled VPN (for LAN-level connectivity) and standard ZTNA (for private applications 102), all under the unified oversight of the cloud-based system 100.

The NP connector 302 provides functionality similar to the application connector 130, but specifically for granting network-level access to the LAN segments 308 instead of per-application access to resources (the applications 102). Like its counterpart, the NP connector 302 is a lightweight software component hosted within the LAN segment 306. However, rather than connecting directly to private applications 102, the NP connector 302 initiates secure tunnels to the NP gateways 320, analogous to how the application connector 130 establishes connections for application-level ZTNA. In this setup, the default gateway 304 (for the LAN) routes all packets destined for remote subnets to the NP connector 302 as the next hop. Acting both as a router and as a tunnel endpoint, the NP connector 302 encapsulates these outbound packets and sends them to the appropriate NP gateway 320 in the cloud-based system 100. On the return path, it de-encapsulates incoming packets and forwards them back to the default gateway 304, which then delivers them to the correct destination on the LAN. This design removes the need for any inbound open ports, since all tunnel connections originate from within the LAN. In some embodiments, the NP connector 302 may be integrated with the application connector 130, allowing organizations to consolidate both LAN-focused and application-focused connectivity into a single software component while maintaining a zero-trust security posture.

Each NP gateway 320 is typically deployed as a virtual machine within the cloud-based system 100, often co-located with the application brokers 346 for efficiency and shared infrastructure. The NP gateway 320 hosts a well-known IP and port pair that both the NP client (running in the client connector 120) and the NP connectors 302 use to initiate WireGuard tunnels. This design leverages outbound-only connections, where the NP client and NP connectors 302 establish secure tunnels to the NP gateway’s known IP address, removing the need to open inbound ports in either the LAN or the cloud environment.

To facilitate client-to-client communication, each NP gateway 320 also forms connections to every other NP gateway 320 in the cloud-based system 100, creating a mesh-like structure. When traffic arrives from an NP client or an NP connector, the NP gateway 320 “bridges” these inbound tunnels—ensuring data can be routed appropriately between different LAN segments or endpoint devices. Notably, the NP gateway 320 only initiates outbound connections when setting up or maintaining these inter-gateway tunnels; it does not accept inbound sessions from unknown sources. This architectural choice enforces a zero-trust posture, as all tunnels originate from trusted components (the client connector 120, NP connectors 302, or other NP gateways 320) and are authenticated via WireGuard’s cryptographic handshakes.

Within the client connector 120, the NP client includes a set of processes or threads tasked with establishing WireGuard tunnels to the NP gateways 320 in a predefined sequence. For instance, the NP client may attempt a connection with the first gateway in a list, then proceed to the second if necessary, and so on. Once a tunnel is successfully created, the NP client configures routes for the Classless Inter-Domain Routing (CIDR) blocks accessible through Network Presence. Additionally, the NP client handles NP FQDN resolution by utilizing pre-configured NP DNS servers, ensuring that any fully qualified domain names within the NP domain are resolved correctly without requiring external DNS lookups.

Establishing and maintaining these secure WireGuard tunnels necessitates robust key management, facilitated by the NP Wally module 340 and the NP DB 342. The NP client, NP connector 302, and NP gateways 320 each include key management logic that collaborates with the NP Wally module 340 for key distribution. Acting as a centralized key authority, the NP Wally module 340 pulls from—or stores keys in—the NP DB 342, thereby synchronizing cryptographic materials across all Network Presence components. This design enforces consistent cryptographic policies, supports re-keying when needed, and ensures each tunnel meets the stringent security requirements of a Zero Trust architecture.

When a remote user or device initiates network presence, the cloud-based system 100 coordinates with the IP Address Reservation Service (IPARS) 344 to assign a unique IP address for the NP client’s virtual interface. As soon as the NP client connects, IPARS consults the NP DB 342 to obtain an available address range specific to Network Presence, then delivers the appropriate IP assignment to the NP client. By managing IP address distribution centrally, IPARS 344 eliminates conflicts and streamlines endpoint provisioning, enabling the NP client to integrate seamlessly with LAN segments and other network services under the Network Presence framework.

### WireGuard tunnels

WireGuard is described in Donenfeld, Jason A. "WireGuard: Next Generation Kernel Network Tunnel." NDSS. 2017, the contents of which are incorporated by reference. WireGuard tunnels provide an efficient, modern approach to securing traffic for Network Presence in ZTNA-enabled VPN environments. Designed as a lightweight Layer 3 VPN solution, WireGuard incorporates state-of-the-art cryptographic primitives (such as Curve25519 for key exchange and ChaCha20 for encryption) in a codebase significantly smaller and simpler than traditional protocols like IPsec or SSL/TLS. This minimal complexity reduces both attack surface and the risk of implementation errors while delivering excellent performance due to its streamlined kernel-space operation. Unlike many SSL- or TLS-based VPN solutions, WireGuard establishes peer connections through ephemeral key pairs and maintains only minimal connection state, allowing rapid reconnection across changing networks or fluctuating IP addresses—ideal for mobile clients. Additionally, its built-in cryptokey routing allows user identity to be tied directly to cryptographic keys, aligning naturally with zero-trust principles by eliminating the need for user-level certificates or complex session management. As a result, organizations deploying ZTNA-enabled VPNs benefit from faster tunnel initialization, lower overhead, and a hardened security model that is easier to audit, maintain, and scale across distributed environments.

### Remote Client Partitions

Remote Client Partitions introduce a method for managing private IP address assignments in a tenant’s network, accommodating both local and remote devices under a unified addressing scheme. Each tenant begins with a superset of private IP addresses, some of which may already be partitioned into subnetworks for on-premises LAN locations. To extend these resources to remote users, the solution creates Remote Private Subnets (RPS)—subsets of the tenant’s address space dedicated to endpoints running the NP client. Each NP gateway 320 fronts an RPS and is usually deployed in a geographic region close to the remote clients it serves, thereby reducing latency and optimizing routing. For fault tolerance, multiple NP gateways 320 can be designated per RPS—collectively known as Designated NP Gateways (DNPGs). Only one is active at a time (the Primary DNPG) due to WireGuard constraints, while the others (the Secondary DNPGs) remain on standby.

When an NP client is unable to connect to its Primary DNPG, it informs the system’s broker, which may reassign the client to a newly elected Primary DNPG or to a DNPG from a neighboring RPS. In all cases, the client’s virtual IP address is managed based on the RPS associated with the NP gateway 320 it connects to. Because NP gateways 320 initiate only outbound connections, there is no need to open inbound firewall ports, thereby maintaining a robust zero-trust posture. By assigning remote endpoints to RPS address pools and leveraging WireGuard tunnels between NP clients and NP gateways 320, the system offers LAN-like access to authorized remote devices without exposing the entire corporate network.

Although each NP gateway 320 fronts an RPS, it does not require an IP address within that subnet. Its primary function is to facilitate route selection and handle the “stitching” of two tunnels: one between the NP client and the NP gateway 320, and the other between the NP gateway 320 and the NP connector 302. This design keeps the NP gateway 320 agnostic to the specific IP space of the RPS while still enabling the secure transport of traffic. On the LAN side, private subnetworks are typically predefined within the tenant’s infrastructure, existing prior to any NP solution deployment. As a result, the LAN partitioning is already in place, and NP merely extends network reach to remote devices. For fault tolerance, most implementations use at least two NP connectors 302 per LAN, configured in a redundant manner.

To handle gateway failover gracefully, the NP client is initially provided with only one NP gateway 320 (the Primary). It attempts to establish a WireGuard tunnel and then checks the tunnel status after a predefined interval. If tunnel creation fails, the NP client notifies the broker, which reassigns the client to another NP gateway 320—potentially a newly elected Primary DNPG or a DNPG from a neighboring RPS. In parallel, the broker manages NP gateway 320 leadership through a “leader election” process, updating the record in Wally (the zero-trust orchestration component) if leadership changes. If the broker detects a discrepancy—such as the broker believing the NP gateway 320 is operational while the client deems it unreachable—it triggers an error recovery procedure on the Primary NP gateway 320, prompting all tunnels to be restarted. Should these recovery steps fail, the broker designates a new Primary NP gateway 320 and instructs all NP clients within the affected RPS to migrate accordingly. In the event of a site-wide outage, the client is redirected to a different broker with a corresponding set of NP gateways, ensuring seamless connectivity and minimal downtime.

### Packet Flow/Tunnel Establishment

The NP connectors 302 maintain active tunnels to every known NP gateway 320, ensuring high availability and efficient traffic routing across the cloud-based system 100. By contrast, the NP clients initiate a WireGuard tunnel only when they come online and connect to the single NP gateway 320 closest to them geographically, minimizing latency. The NP gateways 320 themselves do not initiate any tunnels; instead, they host well-known IP addresses and ports so that the NP connectors 302 and the NP clients can reliably establish outbound connections. This design adheres to zero-trust principles by eliminating the need to open inbound ports. Once connected, the NP clients, the NP gateways 320, and the NP connectors 302 can dynamically add or remove peers as needed, leveraging WireGuard’s native support for ephemeral peer discovery. Underneath these tunnels, actual data packets move between an NP client and an NP segment (or vice versa) via standard Layer 2/Layer 3 forwarding. The NP virtual adapters on each endpoint device 106 handle the encryption and encapsulation, while the NP gateways 320 effectively bridge the two legs of the tunnel—one from the NP client to the NP gateway 320, and the other from the NP gateway 320 to the NP connector 302—thus completing end-to-end secure communication.

### Application Brokers and NP gateways

In most deployments, the NP gateways 320 and application brokers 346 (which facilitate ZTNA private application access) are co-located to streamline communication and reduce latency. By combining ZTNA private application access with a ZTNA-enabled VPN, the application brokers 346 leverage the NP-Wally module 340 to remain aware of available NP gateways and provide initial configuration data—often referred to as bootstrapping information—to the client connector 130 (including the NP client). This information includes details such as the NP gateway’s IP address and port, cryptographic keys or tokens, and any required routing policies for tunnel establishment. On the server side, the same brokers are also responsible for securely fetching the NP-Wally module credentials on behalf of the NP connector 302, allowing both the client connector and NP connector to authenticate and update key materials without direct access to Wally. Notably, the NP gateways 320 themselves connect directly to the NP-Wally module 340 and remain unaware of the broker’s presence, thereby simplifying the gateway’s design and focusing its functionality on managing secure tunnels rather than orchestrating session or identity logic. This layered approach ensures that client connectors, NP connectors, and NP gateways each have precisely the information they need to maintain a zero-trust security posture while offering seamless connectivity for both application-level and network-level access.

### Tunnels and Peering

The NP connectors 302 maintain active tunnels to all known NP gateways 320, as published by the NP-Wally module 340. Whenever a new NP gateway is added, removed, or updated (e.g., due to a key-pair change), the NP-Wally module notifies NP connectors accordingly. Unlike the existing ZTNA mechanism, in which a remote endpoint’s data might pass through an application-layer proxy, the NP approach uses Layer 3 forwarding to carry traffic from an endpoint device 106 to an NP segment. Consequently, the NP connector 302–to–NP gateway 320 tunnels must be established proactively. Meanwhile, on the remote side, the NP client brings up its own tunnel to the NP gateway 320 as soon as it starts. By the time an application attempts to connect to an IP address served through Network Presence, both “legs” of the tunnel path are already in place, eliminating any delay from tunnel setup and ensuring zero-lag connectivity.

All NP components—NP clients, NP gateways 320, and NP connectors 302—use WireGuard to establish secure tunnels. A given NP client forms a single tunnel to its assigned NP gateway 320, while each NP connector 302 forms tunnels with every NP gateway 320. Additionally, NP gateways 320 create peering connections only with other NP gateways 320, forming a mesh or partial mesh structure. WireGuard peers can only be created if both entities possess each other’s public key, ensuring a mutual handshake and a strict trust boundary. This design means that peering relationships and tunnels can dynamically change in several scenarios:

NP Client Startup—When an NP client comes online, its NP gateway 320 must add the client as a new WireGuard peer.

Client Relocation—If an NP client moves to a different geographic region, it may change its NP gateway 320. In this case, the old gateway will remove its peering with the client, while the new gateway adds the client as a peer.

Adding a New NP Gateway—All NP connectors 302 and existing NP gateways 320 must establish new peer connections for the newly introduced NP gateway.

Adding a New NP Connector—Each NP gateway 320 updates its peer list to include the newly added NP connector 302.

Decommissioning a Component—If an NP client, NP gateway, or NP connector is taken out of service, the corresponding WireGuard peers remove its public key and tear down any active tunnels.

Key Rollover—When an endpoint (client, gateway, or connector) undergoes key-pair rotation, peer entries are updated with the new WireGuard public key, prompting reestablishment of secure tunnels.

Through this mechanism, Network Presence ensures continuous adaptability and resilience. Peering relationships evolve in real time, maintaining a secure mesh of connections even in dynamic environments with frequent changes.

### Process

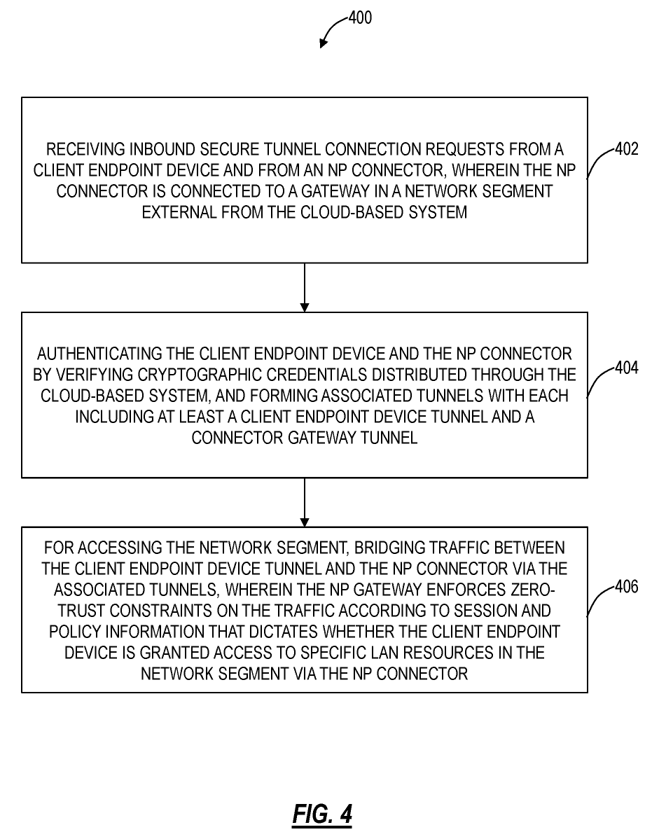

FIG. 4 illustrates a flowchart of a process 400 for enabling zero-trust network access (ZTNA)-enabled virtual private network (VPN) connectivity in a cloud-based system that includes a network presence (NP) gateway 320. The process 400 can be implemented as a method performed by a computing system configured to carry out the described steps, including but not limited to the NP gateway 320, or as instructions stored on a non-transitory computer-readable medium that, when executed by one or more processors, cause the described steps to be performed.

The steps include receiving inbound secure tunnel connection requests from a client endpoint device and from an NP connector, wherein the NP connector is connected to a gateway in a network segment external from the cloud-based system (step 402); authenticating the client endpoint device and the NP connector by verifying cryptographic credentials distributed through the cloud-based system, and forming associated tunnels with each including at least a client endpoint device tunnel and a connector gateway tunnel (step 404); and, for accessing the network segment, bridging traffic between the client endpoint device tunnel and the NP connector via the associated tunnels, wherein the NP gateway enforces zero-trust constraints on the traffic according to session and policy information that dictates whether the client endpoint device is granted access to specific LAN resources in the network segment via the NP connector (step 406).

The steps can further include, for accessing a second client endpoint device, bridging traffic between the client endpoint device tunnel and a second client endpoint device tunnel to the second client endpoint device. The bridging traffic between the client endpoint device tunnel and the second client endpoint device is via the NP gateway when the client endpoint device tunnel and the second client endpoint tunnel are connected thereto; or via the NP gateway and one or more inter-gateway tunnels and one or more additional NP gateways when the second client endpoint tunnel is connected to a different NP gateway. The associated tunnels can include one or more inter-gateway tunnels and one or more additional connector gateway tunnels when the NP connector is connected to a different NP gateway than the NP gateway.

The steps can further include maintaining inter-gateway tunnels to other NP gateways for inter-gateway traffic flow without exposing inbound ports; and maintaining connector gateway tunnels including the connector gateway tunnel and any additional connector gateway tunnels to any additional NP connectors. The inter-gateway tunnels, the connector gateway tunnels, and the client endpoint device tunnel can use a WireGuard-based protocol. The maintaining can include key rotation events as well as addition and removal of NP gateways and NP connectors. The NP gateway is associated with a known Internet Protocol (IP) address and port pair and is configured for outbound-only connections, where the client endpoint device and the NP connector establish secure tunnels to the NP gateway via the known IP address, removing a need to open inbound ports.

The steps can further include, while maintaining parallel secure tunnels to multiple NP connectors each associated with distinct LAN segments, selectively forwarding traffic from the client endpoint device to an appropriate NP connector based on destination subnet definitions and based on the session and policy information. The steps can further include coordinating cryptographic key rotation events for both the client endpoint device and the NP connector, including the NP gateway updating its peer tables upon receiving new cryptographic credentials and gracefully reestablishes tunnels without disrupting live sessions. The steps can further include, for the inbound secure tunnel connection request from the client endpoint device, receiving tunnel-initiation information encapsulated by a client connector application executing on the client endpoint device, wherein the client connector application includes identification, posture, and policy tokens that the NP gateway verifies against zero-trust policies.

The steps can further include forwarding the inbound secure tunnel connection request from the client endpoint device to an application broker in the cloud-based system for application-specific zero-trust validation, wherein the client connector application also supports direct connectivity to an application connector for private application access. The steps can further include enforcing resource segmentation rules that differentiate between LAN-level NP traffic and application-level connections, so that only authorized traffic is forwarded toward the NP connector or the application connector, respectively. The steps can further include obtaining, from a broker service in the cloud-based system, the session and policy information that dictates whether the client endpoint device is granted access to specific LAN resources via the NP connector.

### Co-existence of Zero Trust Tunnel and VPN Tunnel

As described herein, the client connector 120 supports a dual-tunnel approach, providing both ZTNA private application access to applications 102 and ZTNA-enabled VPN connectivity for network segments. In one mode, the client connector 120 establishes a zero-trust tunnel (e.g., TLS or SSL) that directs application-level traffic to the application connector 130, ensuring per-application, least-privileged access. In parallel, the client connector 120 creates a network-layer tunnel—referred to as a GW-client tunnel 356—with the NP gateway 320, which bridges traffic to NP connectors 302 for LAN segments or to another endpoint device 106 as required. This design allows organizations to differentiate traffic flows based on application type or port requirements, automatically routing data either through the zero-trust tunnel for granular, application-specific controls or through the VPN-like network-layer tunnel where broader connectivity (e.g., for VoIP or server-initiated flows) is necessary. By consolidating both approaches within a single ZTNA product, the client connector 120 simultaneously delivers the security benefits of ZTNA—such as least-privileged access and continuous policy enforcement—alongside persistent network-layer connectivity for real-time or legacy use cases. This unified architecture eliminates the need for multiple, disjoint solutions and provides a seamless, centrally managed framework that intelligently orchestrates traffic based on context, device posture, user identity, and application demands.

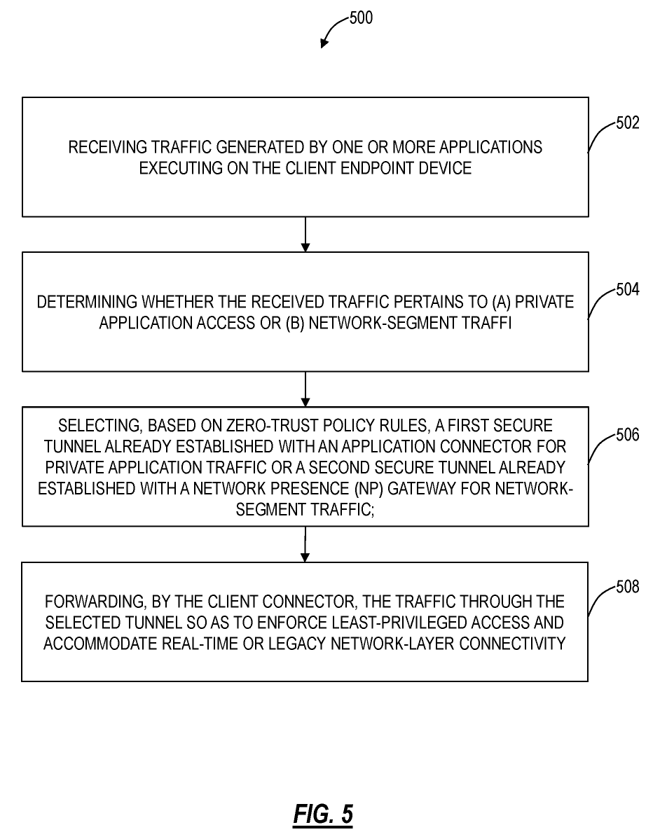

FIG. 5 illustrates a flowchart of a process 500 for providing zero-trust network access (ZTNA) private application connectivity and ZTNA-enabled virtual private network (VPN) connectivity. The process 500 is described with reference to a client endpoint device 106 that includes a client connector 120. The process 500 can be implemented as a method performed by a computing system configured to carry out the described steps, including but not limited to the client endpoint device 106, or as instructions stored on a non-transitory computer-readable medium that, when executed by one or more processors, cause the described steps to be performed.

The steps include receiving traffic generated by one or more applications executing on the client endpoint device (step 502); determining whether the received traffic pertains to (a) private application access or (b) network-segment traffic (step 504); selecting, based on zero-trust policy rules, a first secure tunnel already established with an application connector for private application traffic or a second secure tunnel already established with a network presence (NP) gateway for network-segment traffic (step 506); and forwarding the traffic through the selected tunnel so as to enforce least-privileged access and accommodate real-time or legacy network-layer connectivity (step 508).

The steps can further include establishing, by the client connector prior to receiving the traffic, the first secure tunnel to the application connector using an outbound-only connection, wherein application-specific zero-trust policies are enforced at an application layer. The steps can also further include establishing, by the client connector, the second secure tunnel to the NP gateway via an outbound-only connection, wherein network-segment traffic is routed at the network layer while upholding a zero-trust security posture. The steps can further include analyzing traffic attributes—including destination IP, port, protocol, or application identifier—against policy data stored in the client connector, and selecting either the first secure tunnel or the second secure tunnel in real time based on those attributes.

Both the first secure tunnel and the second secure tunnel are established as outbound connections from the client endpoint device, ensuring no inbound ports are opened at the client endpoint device and maintaining a zero-trust security posture. The first secure tunnel can include a TLS/SSL-based connection with the application connector at an application layer; and the second secure tunnel can include a network-layer tunnel utilizing a protocol selected from the group consisting of WireGuard, IPsec, or a functionally equivalent secure VPN protocol.

The steps can further include performing, at the client connector, periodic device posture checks (including operating system version, security patches, or endpoint health) and automatically adjusting tunnel access if a posture check fails or indicates non-compliance. The steps can further include directing, by the client connector, latency-sensitive or server-initiated traffic flows (including VoIP or remote management protocols) through the second secure tunnel, while routing purely application-specific requests through the first secure tunnel. The steps can further include participating, by the client connector, in a cryptographic key rollover mechanism managed by a broker system, wherein both the first secure tunnel and the second secure tunnel are re-keyed without disrupting active sessions. The steps can further include exposing, via a single management interface of the client connector, consolidated configuration options for both the application-layer tunnel and the network-layer tunnel, enabling an administrator to update zero-trust policies or revoke access globally without installing multiple clients.

### Conclusion

In this disclosure, including the claims, the phrases “at least one of” or “one or more of,” when referring to a list of items, encompass any combination of those items, including any single item. For example, the expressions “at least one of A, B, or C,” “at least one of A, B, and C,” “one or more of A, B, or C,” and “one or more of A, B, and C” cover the possibilities of only A, only B, only C, any combination of A and B, A and C, B and C, or all three (A, B, and C). This also includes scenarios involving more or fewer elements than A, B, and C. Additionally, the terms “comprise,” “comprises,” “comprising,” “include,” “includes,” and “including” are intended to be open-ended and non-limiting, specifying essential elements or steps without excluding additional elements or steps—even where a claim or multiple claims contain more than one such term.

It should be understood that the drawings, descriptions, and examples provided herein merely illustrate various aspects and embodiments of the disclosure. Numerous modifications, changes, or arrangements may be made without departing from the spirit and scope of the disclosure. Although certain steps, operations, instructions, blocks, or similar elements (collectively referred to as “steps”) are depicted or described in a specific order, such ordering is not necessarily required unless explicitly stated. Nor does it imply that all depicted steps are essential to achieve the desired results. Extra steps may be performed before, after, concurrently, or interspersed with the illustrated or described steps. Multitasking, parallel processing, and other types of concurrent execution are also contemplated. Further, the separation of system components or steps described should not be interpreted as mandatory in all implementations; such components, steps, or elements may be integrated into a single configuration or distributed across multiple ones.

While this disclosure has been shown and described through specific embodiments and examples, those skilled in the art will recognize that many variations and modifications can provide equivalent functionality or yield comparable results. Such alternative embodiments and variations, even if not explicitly mentioned here, fall within the spirit and scope of this disclosure if they achieve the stated objectives and adhere to the underlying principles. Accordingly, they are envisioned and encompassed by the disclosure and protected by the associated claims. In other words, the present disclosure anticipates combinations and permutations of the described elements, operations, steps, methods, processes, algorithms, functions, techniques, modules, and circuits in any feasible sequence or arrangement—whether collectively, separately, or in subsets—thereby broadening the range of potential embodiments.

What is claimed is:

1. A method for enabling zero-trust network access (ZTNA)-enabled virtual private network (VPN) connectivity in a cloud-based system comprising a network presence (NP) gateway, the method comprising step of, at the NP gateway:
receiving inbound secure tunnel connection requests from a client endpoint device and from an NP connector, wherein the NP connector is connected to a gateway in a network segment external from the cloud-based system;
authenticating the client endpoint device and the NP connector by verifying cryptographic credentials distributed through the cloud-based system, and forming associated tunnels with each including at least a client endpoint device tunnel and a connector gateway tunnel; and
for accessing the network segment, bridging traffic between the client endpoint device tunnel and the NP connector via the associated tunnels, wherein the NP gateway enforces zero-trust constraints on the traffic according to session and policy information that dictates whether the client endpoint device is granted access to specific LAN resources in the network segment via the NP connector.

2. The method of claim 1, wherein the steps further include:
for accessing a second client endpoint device, bridging traffic between the client endpoint device tunnel and a second client endpoint device tunnel to the second client endpoint device.

3. The method of claim 2, wherein the bridging traffic between the client endpoint device tunnel and the second client endpoint device is
via the NP gateway when the client endpoint device tunnel and the second client endpoint tunnel are connected thereto; or
via the NP gateway and one or more inter-gateway tunnels and one or more additional NP gateways when the second client endpoint tunnel is connected to a different NP gateway.

4. The method of claim 1, wherein the associated tunnels include one or more inter-gateway tunnels and one or more additional connector gateway tunnels when the NP connector is connected to a different NP gateway than the NP gateway.

5. The method of claim 1, wherein the steps further include:
maintaining inter-gateway tunnels to other NP gateways for inter-gateway traffic flow without exposing inbound ports; and
maintaining connector gateway tunnels including the connector gateway tunnel and any additional connector gateway tunnels to any additional NP connectors.

6. The method of claim 5, wherein the inter-gateway tunnels, the connector gateway tunnels, and the client endpoint device tunnel use a WireGuard-based protocol.

7. The method of claim 5, wherein the maintaining includes key rotation events as well as addition and removal of NP gateways and NP connectors.

8. The method of claim 1, wherein the NP gateway is associated with a known Internet Protocol (IP) address and port pair and is configured for outbound-only connections, where the client endpoint device and the NP connector establish secure tunnels to the NP gateway via the known IP address, removing a need to open inbound ports.

9. The method of claim 1, wherein the steps further include:
while maintaining parallel secure tunnels to multiple NP connectors each associated with distinct LAN segments, selectively forwarding traffic from the client endpoint device to an appropriate NP connector based on destination subnet definitions and based on the session and policy information.

10. The method of claim 1, wherein the steps further include:
coordinating cryptographic key rotation events for both the client endpoint device and the NP connector, including the NP gateway updating its peer tables upon receiving new cryptographic credentials and gracefully reestablishes tunnels without disrupting live sessions.

11. The method of claim 1, wherein the steps further include:
for the inbound secure tunnel connection request from the client endpoint device, receiving tunnel-initiation information encapsulated by a client connector application executing on the client endpoint device, wherein the client connector application includes identification, posture, and policy tokens that the NP gateway verifies against zero-trust policies.

12. The method of claim 11, wherein the steps further include:
forwarding the inbound secure tunnel connection request from the client endpoint device to an application broker in the cloud-based system for application-specific zero-trust validation, wherein the client connector application also supports direct connectivity to an application connector for private application access.

13. The method of claim 12, wherein the steps further include:
enforcing resource segmentation rules that differentiate between LAN-level NP traffic and application-level connections, so that only authorized traffic is forwarded toward the NP connector or the application connector, respectively.

14. The method of claim 1, wherein the steps further include:
obtaining, from a broker service in the cloud-based system, the session and policy information that dictates whether the client endpoint device is granted access to specific LAN resources via the NP connector.

15. A network presence (NP) gateway in a cloud-based system for enabling zero-trust network access (ZTNA)-enabled virtual private network (VPN) connectivity, the NP gateway comprising:
one or more processors; and
memory storing instructions that, when executed, cause the one or more processors to:
receive, via network interfaces, inbound secure tunnel connection requests from a client endpoint device and from an NP connector, wherein the NP connector is connected to a gateway in a network segment external from the cloud-based system;
authenticate the client endpoint device and the NP connector by verifying cryptographic credentials distributed through the cloud-based system, and form associated tunnels with each including at least a client endpoint device tunnel and a connector gateway tunnel; and
for accessing the network segment, bridge traffic between the client endpoint device tunnel and the NP connector via the associated tunnels, wherein the NP gateway enforces zero-trust constraints on the traffic according to session and policy information that dictates whether the client endpoint device is granted access to specific LAN resources in the network segment via the NP connector.

16. The NP gateway of claim 15, wherein the instructions that, when executed, further cause the one or more processors to:
maintain inter-gateway tunnels to other NP gateways for inter-gateway traffic flow without exposing inbound ports; and
maintain connector gateway tunnels including the connector gateway tunnel and any additional connector gateway tunnels to any additional NP connectors.

17. The NP gateway of claim 15, wherein the NP gateway is associated with a known Internet Protocol (IP) address and port pair and is configured for outbound-only connections, where the client endpoint device and the NP connector establish secure tunnels to the NP gateway via the known IP address, removing a need to open inbound ports.

18. A client endpoint device that includes a client connector, for using pre-established tunnels to provide zero-trust network access (ZTNA) private application connectivity and ZTNA-enabled virtual private network (VPN) connectivity, the client endpoint device comprising:
one or more processors and memory storing instructions that, when executed, cause the one or more processors to implement the client connector to
receive traffic generated by one or more applications executing on the client endpoint device;
determine whether the received traffic pertains to (a) private application access or (b) network-segment traffic;
select, based on zero-trust policy rules, a first secure tunnel with an application connector for private application traffic or a second secure tunnel with a network presence (NP) gateway for network-segment traffic; and
forward the traffic through the selected tunnel so as to enforce least-privileged access and accommodate real-time or legacy network-layer connectivity.

19. The client endpoint device of claim 18, wherein the client connector is further configured to:
establish prior to receiving the traffic,
the first secure tunnel to the application connector using an outbound-only connection, wherein application-specific zero-trust policies are enforced at an application layer, and
the second secure tunnel to the NP gateway via an outbound-only connection, wherein network-segment traffic is routed at the network layer while upholding a zero-trust security posture.

20. The client endpoint device of claim 18, wherein the client connector is further configured to:
analyze traffic attributes, including destination IP, port, protocol, or application identifier, against policy data stored in the client connector, and select either the first secure tunnel or the second secure tunnel in real time based on those attributes.
